(19) United States
(12) Patent Application Publication
(10) Pub. No.: US 2026/0067951 A1
(43) Pub. Date: Mar. 5, 2026

(54) SYSTEMS AND METHODS FOR FORMING WIRELESS CONNECTIONS BY A READVERTISING OPERATION

(71) Applicant: The Chamberlain Group LLC, Oak Brook, IL (US)

(72) Inventors: Edward Bandyk, Woodridge, IL (US); Robert Jude Axtolis, Naperville, IL (US); David Louis Toubes, Northbrook, IL (US); Daniel James Even, Downers Grove, IL (US)

(21) Appl. No.: 18/819,695

(22) Filed: Aug. 29, 2024

(51) Int. Cl. H04W 76/11

(52) U.S. Cl. CPC H04W 76/11

(57) ABSTRACT

An advertising device for performing a readvertising operation for wirelessly connecting with a plurality of connecting devices. The advertising device transmits an advertising signal for establishing connection with the plurality of connecting devices. In response, the advertising device receives a plurality of connection requests from the plurality of connecting devices and transmits a first connection response to the first discernable connection request that was received from a first connecting device of the plurality of connecting devices, thereby establishing a first wireless connection between the advertising device and the first connecting device. In response to establishing the first wireless connection, the advertising device retransmits the advertising signal to establish connection with the others of the plurality of connecting devices.

### BACKGROUND

In traditional remote-controlled movable barrier systems, a controlling device acts as a transmitter and sends a unidirectional transmission to an operator of the movable barrier for controlling the movable barrier. In these traditional systems, it is possible to learn multiple operators to a single controlling device such that, when the controlling device is activated, all of the listening operators will receive the commanding transmission and act in unison accordingly. Said another way, traditional controlling devices can be configured to control operations of multiple operators using a single unidirectional commanding transmission.

As stated, these traditional systems do not require that a connection be formed between the controlling device and the operator, as the systems essentially comprise a transmitter sending a unidirectional signal to a receiver. For various reasons, remote-controlled movable barrier systems are improved when a bidirectional communication connection is formed between the controlling device and the movable barrier operator. For example, using a bidirectional communication connection can allow for a secure connection between the two devices, such as an encrypted connection, to allow for secure operational commands from the controlling device to the operator and secure bidirectional data transfer and between the two devices.

### SUMMARY

The disclosed examples are described in detail below with reference to the accompanying drawing figures listed below. The following summary is provided to illustrate some examples disclosed herein.

Example solutions include systems and associated methods for performing a readvertising operation for forming a bidirectional communication connection between an advertising device and each of a plurality of connecting devices. One such method includes transmitting, by the advertising device, an advertising signal for establishing connection with the plurality of connecting devices, the advertising signal including a unique identifier (UID) and receiving, by the plurality of connecting devices, the advertising signal. The method further includes determining, by each of the plurality of connecting devices, whether the connecting device has connected with the advertising device based on recognition of the UID. For each of the plurality of connecting devices determining that the connecting device has connected with the advertising device based on recognizing the UID, the method further includes ignoring the advertising signal. But, for each of the plurality of connecting devices determining that the connecting device has not connected with the advertising device based on not recognizing the UID, the method further includes transmitting a connection request, and receiving, by the advertising device, a plurality of the connection requests. The method further includes determining, by the advertising device, which of the plurality of connection request is a first connection request that was received by the advertising device first of out of the plurality of connection requests, and transmitting a first connection response to a first connecting device of the plurality of connecting devices from which the first connection request was transmitted. Thereby a first wireless connection is established between the advertising device and the first connecting device. The method further includes, in response to establishing the first wireless connection, the advertising device retransmitting the advertising signal including the UID for establishing connection with others of the plurality of connecting devices.

### BRIEF DESCRIPTION OF THE DRAWINGS

The disclosed examples are described in detail below with reference to the accompanying drawing figures listed below:

FIG. 1 illustrates a movable barrier system, according to an example of this disclosure;

FIG. 2 is a block diagram illustrating an example of a user-operated control device of the system of FIG. 1;

FIG. 3 is a block diagram illustrating an example of a movable barrier operator of the system of FIG. 1;

FIGS. 4A and 4B are diagrams illustrating a system for performing a readvertising operation;

FIG. 5 is a flowchart illustrating a method for performing a readvertising operation by an advertising device;

FIG. 6 is a flowchart illustrating a method for performing a readvertising operation by a connecting device;

FIG. 7 is a diagram illustrating a system for performing a readvertising operation, according to another example of this disclosure; and

FIG. 8 is a flowchart illustrating a method for performing a readvertising operation by an advertising device, according to another example of this disclosure.

Corresponding reference characters indicate corresponding parts throughout the drawings.

### DETAILED DESCRIPTION

For various reasons, remote-controlled movable barrier systems are improved when a bidirectional communication connection is formed between the controlling device and the movable barrier operator. For example, using a bidirectional communication connection can allow for a secure connection between the two devices, such as an encrypted connection, to allow for secure operational commands from the controlling device to the operator and secure bidirectional data transfer and between the two devices.

Because bidirectional connections do not allow for a single transmission to be broadcast such that multiple devices can act on the single broadcast transmission, controlling multiple operators via bidirectional communication connections with a single activation of a single controlling device has been unachievable. Accordingly, there has been a need for remote-controlled movable barrier systems where a bidirectional communication connection is formed between a controlling device and multiple operators such that the operators can be controlled en masse based on a single activation of the controlling device.

As will be discussed in greater detail below, example solutions of this disclosure provide for a controlling device performing a readvertising operation for forming a wireless connection with multiple movable barrier operators for controlling the operators based on a single activation of the controlling device.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

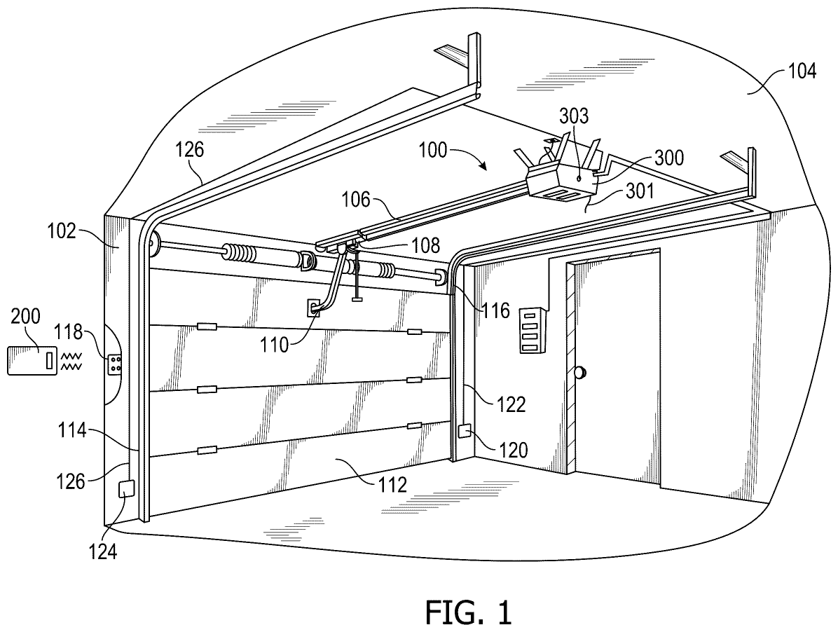

FIG. 1 illustrates a moveable barrier operator system 100 that includes a movable barrier operator 300 and a control device 200. As shown, according to some examples, system 100 is utilized in a garage 102 setting. Control device 200 can comprise any of various known control devices, such as, for example, a handheld device such as a remote control, a wall-mounted control device, a control device integral to a vehicle, or the like. In the illustrated example, operator 300 is mounted to the ceiling 104 of the garage 102 and includes a rail 106 extending therefrom with a releasable trolley 108 attached having an arm 110 extending to a barrier 112 positioned for movement along a pair of door tracks 114, 116. In this example depicting a garage 102 setting, barrier 112 comprises a garage door. Control device 200 is adapted to send signals to and receive signals from the operator 300. An antenna 301 may be positioned on the operator 300 and coupled to a receiver as discussed hereinafter in order to receive transmissions from the control device 200. An external control pad 118 may also be positioned on the outside of the garage 102 and include a user interface thereon for receiving user commands that are communicated via radio frequency transmission with the antenna 301 of the operator 300. In some examples, the external control device 118 is accessible from an outside location and in some examples constitutes a control device 200. An optical emitter 120 may be connected via a power and signal line 122 to the operator 300 with an optical detector 124 connected via a wire 126 to the operator 300 in order to prevent closing of the barrier 112 on a person or object inadvertently in the door's path. An input such as a button or switch 303 may be provided for switching the operator 300 between modes, such as operating mode and learn mode. FIG. 1 depicts an illustrative example of a movable barrier system according to one example of this disclosure in a garage environment, and those with skill in the art will recognize that various other movable barrier examples in various other settings fall within the scope of this disclosure. For example, other movable barrier environments of this disclosure include environments such as over-head doors used for bays, room dividers, gates, and any other movable barrier controlling or providing access to an area.

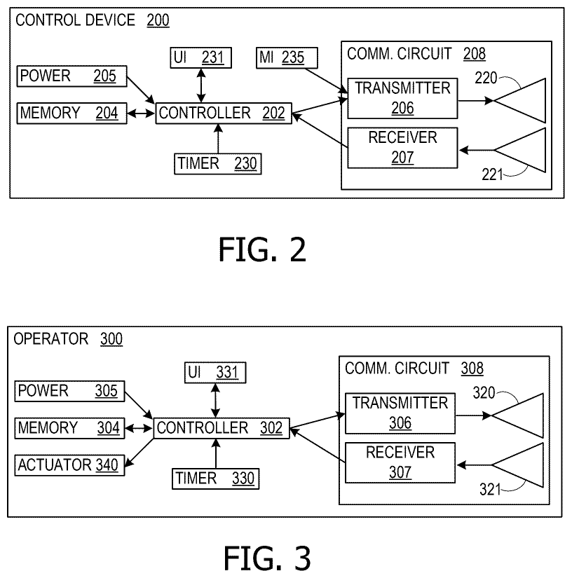

FIG. 2 illustrates a block diagram of the control device 200. Control device 200 includes a communication circuit 208 comprising both a transmitter 206 and receiver 207 (which may be combined into a single transceiver mechanism) in operative communication with antennas 220 and 221, respectively. The antennas can be positioned in, on, or extending from the control device 200, wherein the transmitter 206 and receiver 207 are configured for wirelessly transmitting and receiving transmission signals to and from the operator 300, including transmission signals that contain a first rolling access code with a fixed code portion and a rolling code portion. In some embodiments, both the transmitter and receiver may communicate with a single antenna or multiple antennas, and in some examples the transmitter and receiver may be configured to be a single transceiver device in communication with a single antenna. Control device 200 also includes a controller 202 in operative communication with the transmitter 206 and a memory 204 and is configured for processing data and carrying out commands. The memory 204 may be, for instance, a non-transitory computer readable medium, and may have stored thereon instructions that when executed by a controller circuit cause the controller circuit to perform operations. A power source 205 is coupled to the controller 202 and/or other components, and may be routed in some embodiments so that a user interface (UI), such as UI 231, couples/decouples the power source to other components so that power is supplied only upon activation of the UI 231 or a specified time thereafter. Controller 202 is configured to generate the transmission signal with a signal identifier and cause the transmitter 206 to transmit the signal, and the receiver 207 is configured to receive responsive transmissions from one or more operators 300. Optionally, a timer 230 in communication with the controller 202 enables the controller 202 to determine the time of incoming and outgoing signal transmissions and provides reference for the controller 202 to enable and disable the transmitter 206 and/or receiver 207 of the device. In some embodiments, a manual setting interface (MI) 235 may be provided, which in some forms may include one or more dual in-line package (DIP) switches or other devices configured to allow a user to configure a setting or state of the controller 202. MI 235 may be operatively coupled to the transmitter 206 in order to allow for signal transmissions including information regarding the current setting or state of the manual setting interface. Memory 204 is connected for operative communication with controller 202 and is configured to store data such as codes and, in some examples, other information for outgoing transmissions. Memory 204 is further configured to store fixed and/or changing or variable code information for comparison to incoming transmissions.

UI 231 may include one or more user-operable switches for inputting commands to the control device 200, for example to issue a barrier movement command or a learning command. UI 231 may be associated with a button, lever, or other device to be actuated, for example by a user's hand or other actions, events, or conditions. As other examples, the UI 231 may be voice operated or operated by a user contacting a touch-sensitive screen as the location of an object displayed on the screen. The UI 231 may include multiple buttons, levers, switches, displays, microphone(s), speaker(s), or other inputs associated with different tasks, or operations, to be carried out by the operator 300. As one example, the UI 231 includes a plurality of mechanical buttons that each operate a respective switch. As another example, UI 231 includes a display with one or more virtual buttons.

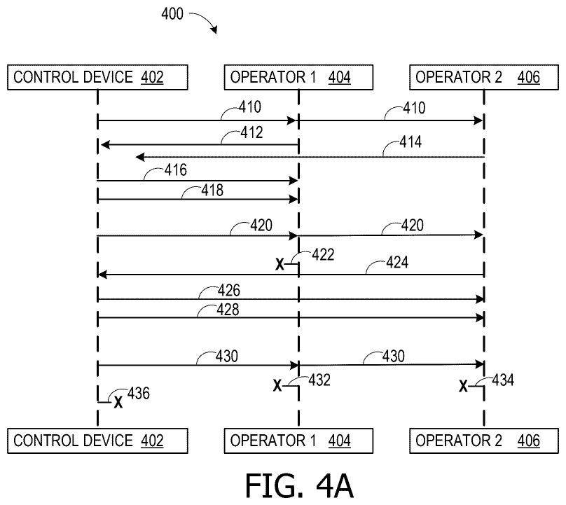

FIG. 3 illustrates a block diagram of operator 300. According to various examples, the operator 300 includes a controller 302 in communication with a memory 304 and is configured for storing and retrieving data to and from the memory 304 as well as processing data and carrying out commands. A power source 305, such as an AC power conduit, battery, or other type of power source, supplies electricity to the controller 302 to allow operation. As an example, power source 305 may include an AC power conduit, a power conditioning circuit, a battery, and/or a battery charging circuit. Operator 300 also includes a communication circuit 308 comprising a wireless transmitter 306 and receiver 307 (or combination transceiver device) in operative communication with the controller 302. As shown, transmitter 306 communicates with a first antenna 320 and receiver 307 communicates with a second antenna 321, but both devices may communicate with a single antenna or multiple antennas, and in some embodiments the device may be configured to have a single transceiver device in communication with a single antenna. The antennas may be positioned in, on, or extending from the operator 300. In this regard, signals, such as radio frequency or other wireless transmission carriers, may be sent to and received from the control device 200 according to a variety of frequencies or modulations. Signals may be modulated in a number of different ways; thus, the control device 200 and movable barrier operator 300 may be configured to communicate with one another via a variety of techniques. Controller 302 of the operator 300 is also in communication with an actuator such as an actuator 340 in order to carry out an operation such as moving a barrier, which may include for example lifting or lowering a bay or a garage door; sliding, swinging, or rotating a gate; or otherwise moving or repositioning a barrier structure. Actuator 340 can comprise any actuating device for moving the associated movable barrier, such as, for example, a motor, a pneumatic or hydraulic actuator, a linear motion actuator, a rotary actuator, or the like.

User Interface (UI) 331, which includes one or more input devices such as buttons, keys or a touch-screen interface, for example, receives user input to override the controller 302 or place the controller in and out of a learning mode in which the operator 300 may be paired with a user-operated device, such as control device 200, by exchanging and storing messages.

The term controller refers broadly to any microcontroller, application specific integrated circuit (ASIC), field programmable gate array (FPGA), computer, state machine, or processor-based device with processor, memory, and programmable input/output peripherals, which is generally designed to govern the operation of other components and devices. It is further understood to include common accompanying accessory devices. The controller can be implemented through one or more processors, microprocessors, central processing units, logic, local digital storage, firmware, software, and/or other control hardware and/or software and may be used to execute or assist in executing the steps of the processes, methods, functionality, and techniques described herein. Furthermore, in some implementations the controller may provide multiprocessor functionality. These architectural options are well known and understood in the art and require no further description here. The controllers may be configured (for example, by using corresponding programming stored in a memory as will be well understood by those skilled in the art) to carry out one or more of the steps, actions, and/or functions described herein.

When a user actuates UI 231 of the control device 200, such as by pressing a button designated as performing a particular action, the controller 202 activates the transmitter 206 to transmit through antenna 220 a message based on information stored in the memory 204. The message is received by the receiver 307 of operator 300 and communicated to the operator's controller 302. In some embodiments, the controller 302 verifies the message by comparing the message to stored information from the operator's memory module 304, and upon verification the controller 302 is configured to cause transmission of a response signal from the transmitter 306 through antenna 320. If the message from the user-actuated control device 200includes information relating to timing parameters for a response, the operator's controller 302 receives time information from a timer 330 in order to determine when to transmit the response in order to comply with timing parameters of the control device 200.

The control device 200 may be configured to verify that the response from the operator 300 complies with transmitted timing requirements in any number of ways. In some embodiments, controller 202 may compare a time stamp or other timing information relating to the operator's response to the transmitted time parameter using timer 230. In some embodiments, receiver 207 is generally inactive, but switched on by controller 202 only for a short time period consistent with the transmitted timing parameter. For instance, controller 202 may switch on receiver 207 for a window of time matching a time window transmitted in an outgoing message through transmitter 206, and upon expiration of the time window according to timer 230, controller 202 switches receiver 207 off again. Timing information may be either relative, for instance a specified number of seconds, milliseconds, or nanoseconds after transmission of an outgoing signal or other event, or may be absolute such as standard date and time information for a specific time zone. A timing synchronization protocol may be provided in some forms in order to maintain precision of timing with other devices despite drift or other factors.

As discussed, communication circuits 208, 308 can comprise two-way communication circuits configured to both transmit and receive communications signals. In some examples, communication circuits 208, 308 comprise short-range wireless communication modules, such as Bluetooth or Bluetooth low energy (BLE) modules or circuits, for example. As such, as those with skill in the art will understand, all wireless communication connections referred to herein utilized by operators 300 and control devices 200 can be any known short-range wireless communication connections, such as Bluetooth or BLE connections, for example.

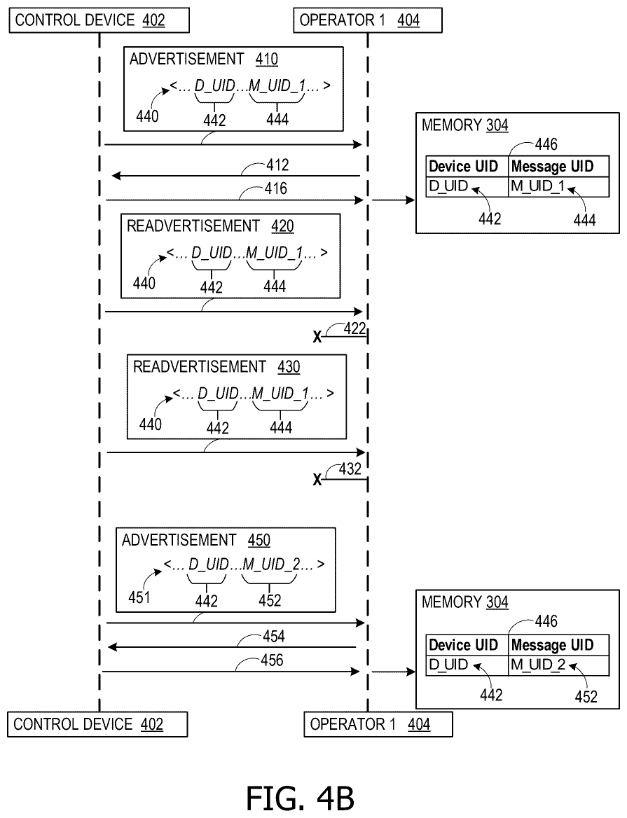

FIG. 4A is a diagram illustrating a system 400 in which a control device 402 uses a readvertising operation to connect to a plurality of operators, such as operators 404 and 406 depicted for illustrative purposes. For example, the connections can be bidirectional short-range wireless communication connections, such as Bluetooth or BLE connections. Control device 402 can comprise any of the various control devices disclosed herein, such as, for example, control device 200. Operators 404, 406 can comprise any of the operators disclosed herein, such as, for example, operator 300.

Herein, control device 402 may be referred to as an “advertising device,” as control device 402 sends advertisements for connection to devices receiving the advertisements, as will be discussed in greater detail below. Additionally, operators 404, 406 can be referred to herein as “connecting devices” because they are the devices that request connection with the device sending the advertising signal. As will be recognized by those with skill in the art, control devices herein can also be referred to as peripheral devices that transmit advertisements and operators herein can be referred to as central devices that receive the advertisement and request connection in response, according to terminologies commonly used in BLE and similar two-way communication connection environments. Although in this example, control device 402 is depicted as the “advertising” device and operators 404, 406 are depicted as the “connecting” devices, those with skill in the art will understand that various other system scenarios fall within the scope of this disclosure. Additionally, while there are two operators 404, 406, and one control device 402 those with skill in the art will recognize system 400 can comprise more than two operators and more than one control device.

The readvertising operation begins with control device 402 sending a connection advertisement signal 410 to any of a plurality of listening operators, such as operators 404, 406. Control device 402 and operators 404, 406 may be BLE or similar two-way communication devices that communicate with each other by first forming a wireless connection for two-way communication, in this example. As will be discussed in greater detail below, in some examples, control device 402 first connects with learned operators and can then initiate a learning process with any unlearned operators after connecting with the learned operators. In the depicted example, operators 404, 406 are already learned or otherwise paired with control device 402, and the connection advertisement signal 410 is received by both operators 404, 406.

As will be discussed in greater detail in FIG. 4B, advertisement signal 410 includes a protocol data unit (PDU) which, as those with skill in the art will recognize, includes various protocol, control, and device data. In some examples, included in the PDU is a device-specific UID, which is a fixed UID unique to the control device 402, similar to a serial number, and is included in each transmission sent from control device 402 for identifying the source of the transmission. In some examples, the PDU further includes a message UID unique to the advertisement 410 and generated by controller 202 as a unique to the message being transmitted. Unlike the device UID which is fixed, the message UID is a variable ID unique to the message and can be included as part of the PDU of advertisement 410 according to any of a number of known methods, such as by rolling code or a unique sequence ID. As will be discussed in greater detail below, operators 404, 406 will attempt to connect with control device 402 if the operators 404, 406 do not recognize an existing connection with control device 402 based on the device and message UIDs. As shown, in response to referencing UIDs from a most-recent connection and not recognizing the device UID or message UID included in advertisement 410 (as will be discussed in greater detail in FIG. 4B), operator 404 sends a connection request 412 to control device 402 and operator 406 sends a connection request 414 to control device 402.

Control device 402 forms connections with the plurality of operators 404, 406 one at a time. Control device 402 forms connections based on which connection request is received first. As shown, in this example, control device 402 receives connection request 412 first, before it receives connection request 414. Accordingly, since it receives connection request 412 first, control device 402 proceeds with connecting with operator 404 by sending a connection response 416 to operator 404 and thereby establishing a wireless connection with operator 404. After forming the wireless connection with operator 404, control device 402 and operator 404 can communicate with each other via the wireless connection. Specifically, control device 402 can transmit a command signal 418 to operator 404. As will be discussed in greater detail below, the readvertising operation may be initiated by control device 402 to connect with the operators 404, 406 to ultimately control the operation of operators 404, 406, such as commanding the operators to actuate their associated moveable barriers. After connection is established with operator 404, control device 402 sends command signal 418 to command the operator 404 to perform an action on its associated moveable barrier, such as to open or close the barrier, for example. In some examples, after command signal 418 is delivered to operator 404, the wireless connection between operator 404 and control device 402 is disconnected. Control device 402 does not take any actions responsive to connection request 414, as the control device responds to the first request received, and connection request 414 is not received first. Accordingly, it can be said that control device 402 ignores connection request 414. Because operator 406 does not receive a response responsive to request 414, operator 406 will exit a connecting state and start scanning again for advertisement. Connection with operator 406 is still achieved by control device 402 via a readvertisement, as discussed in the following operations.

After connection with operator 404 is established and command signal 418 is delivered, control device 402 again transmits an advertisement signal 420 including the same device and message UIDs that were included in advertisement signal 410 to any listening devices. Thus, it can be said that advertisement 420 is a “readvertisement” or “retransmitted advertisement” of the initial advertisement 410. Readvertisement 420 is received by each of the operators 404, 406 for processing. Operator 404 recognizes the device and message UIDs included in readvertisement 420. As discussed in greater detail in FIG. 4B, after forming a wireless connection with control device 402 stemming from the initial advertisement 410, operator 404 stores the device and message UIDs included in advertisement 410 in a UID table of memory 304 for future reference. Operator 404 controller 302 includes logic that instructs operator 404 not to attempt to connect with an advertisement including the same device UID and message UID stored in the UID table. Accordingly, in response to receiving readvertisement 420 with the same device and message UIDs as advertisement 410 stored in the UID table, operator 404 does not send a connection request in response to readvertisement 420 or take any other action for connecting with control device 402. Said another way, operator 404 “ignores” readvertisement 420, as depicted in FIG. 4A with reference numeral 422.

However, operator 406 did not connect with control device 402 responsive to advertisement 410 and thus does not have the device UID or the message UID from advertisement 410 stored in its UID table for reference when creating connection requests. Accordingly, operator 406 does not recognize the device UID and message UID in readvertisement 420 from its UID table and thus sends a connection request 424 to control device 402. In response to receiving connection request 424, control device 402 sends a connection response 426 to operator 406 and thereby establishes a wireless connection with operator 406. While connected with operator 406, control device 402 sends command signal 428, which is the same as command signal 418. As previously discussed, the readvertisement operation can be performed by control device 402 in order to deliver a common command signal to each other the plurality of operators 404, 406. For example, the control device 402 may be activated by the user to close/open each movable barrier connected with a plurality of operators, such as operators 404, 406. For example, if command signal 418 commands operator 404 to close its associated moveable barrier, then command signal 428 also commands operator 406 to close its associated moveable barrier. In some examples, after command signal 428 is delivered to operator 406, the wireless connection between operator 406 and control device 402 is disconnected. After forming a connection with control device 402, the device and message UIDs from the readvertisement 420 are stored in operator's 406 UID table of memory 304 for referencing in generating new connection request responsive to advertisements.

After connection with operator 406 is established and command signal 428 is delivered, control device 402 again transmits a connection advertisement signal 430 including the same device and message UIDs that were included in advertisement 410 and 420 to any listening devices for processing. Again, like advertisement 420, advertisement 430 can be referred to as a readvertisement since it includes the same UIDs included in advertisements 410, 420. Just as it did in response to receiving readvertisement signal 420, operator 404 again ignores 432 readvertisement 430 based on operator 404 recognizing the UIDs being stored in its UID table based on its connection with control device 402 stemming from advertisement 410. Similarly, operator 406 ignores 434 readvertisement 430 based on operator 406 recognizing the UIDs being stored in its UID table based on its connection with control device 402 stemming from readvertisement 420. Thus, control device 402 does not receive any connection request responsive to readvertisement 430, in this example. Control device 402 can continue to readvertise with advertisement 430 for a readvertising period of time. For example, control device 402 can continue to advertise for 400 milliseconds in some examples. If, during the readvertising period of time, control device 402 does not receive any connection requests, control device 402 can end the readvertisement operation, as depicted with reference numeral 434.

Although FIG. 4A depicts system 400 as including two operators, 404, 406, those with skill in the art will understand how the readvertising operation described can be used to connect control device 402 with any of a number of operators. Additionally, those with skill in the art will understand that while system 400 illustrates one control device 402, various similar systems including more than one control device fall within the scope of this disclosure.

As described, the readvertising process allows control device 402 to operate the moveable barriers associated with operators 404, 406 in a sequential and nearly-instantaneous fashion. For example, the actuation of barriers in response to command signals 418 and 428 may be only milliseconds apart. For example, after command signal 418 is sent, operator 404 will actuate its barrier according to the command signal 418 and the control device 402 will proceed immediately to sending readvertisement 420. As stated, control device 402 will advertise with readvertisement 420 for a predetermined period of time, such as for 400 milliseconds, for example. After connecting with operator 406, command signal 428 is sent and operator 406 will actuate its barrier according to the command. Accordingly, the time between operator 404 actuating its barrier and operator 406 actuating its barrier can be very close to the 400 milliseconds of readvertising time, according to some examples.

FIG. 4B is a diagram illustrating operations performed by connecting devices in recognizing and acting upon advertisements from advertising devices. In this illustrative example, control device 402 is shown as the advertising device and operator 404 is shown as the connecting device. As previously discussed, advertisement 410 comprises a PDU 440 which comprises various protocol, control, and device data, such as device UID 442 and message UID 444. Device UID 442 is a fixed identifier associated with the control device 402 and is included in transmissions sent by control device 402 for identifying the source of the transmission. Message UID 444 is a UID unique to the specific message being transmitted, and can therefore be referred to as a variable identifier, as the controller 202 will generate a new message UID for each new message initiated by a new initiating input of the control device 402. Message ID 444 can be generated by controller 202 according to any of a number of known methods, such as by rolling code or a unique sequence ID. In some examples, device UID 442 comprises five bytes of PDU 440, with one byte defining a device type of the control device 402 and four bytes defining the unique fixed identifier for the control device 402. In some examples, message UID 444 comprises four bytes of PDU 440 defining the variable unique identifier. Those with skill in the art will understand that, according to various examples of this disclosure, device UID 442 comprises more or less than five bytes and message UID 444 comprises more or less than four bytes.

As previously discussed, controller 302 of operator 404 receives advertisement 410 and will not have message UID 444 stored to its UID table 446 based on advertisement 410 being the first advertisement sent by control device responsive to an initiating input received at control device 302. Further, controller 302 may not have device UID 442 stored to UID table 446, as operator's 404 most recent previous connection may have been with a different control device. Accordingly, in response to device UID 442 and/or message UID 444 not matching entries in UID table 446, controller 302 generates and transmits connection request 412 and in response to connection request 412 receives connection response 416, thereby forming a communication connection between operator 404 and control device 402. After the connection is formed, controller 302 updates UID table 446 in memory to 304 to include the device UID 442 and message UID 444 included in advertisement 410 for future reference. For example, upon receiving readvertisement 420, controller 302 will identify the device UID 442 and message UID 444 from readvertisement 420 and compare the UIDs against the entries in table 446. Controller 302 recognizes readvertisement's 420 device UID and message UID already match the UID entries in table 446 and thereby determines that controller 302 has already connected responsive to this advertisement and will not attempt to connect to readvertisement 420. As described, operator 404 ignores 422 advertisement 420.

Similarly, upon receiving readvertisement 430, controller 302 will identify the device UID 442 and message UID 444 from readvertisement 430 and compare the UIDs against the entries in table 446. Controller 302 recognizes readvertisement's 430 device UID and message UID already match the UID entries in table 446 and thereby determines that controller 302 has already connected responsive to this advertisement and will not attempt to connect to readvertisement 430. As described, operator 404 ignores 432 advertisement 430.

However, at a later point in time, control device 402 may generate a new advertisement 450 responsive to a new initiating input at control device 402. As shown, PDU 451 includes the fixed device UID 442, but has an updated message UID 452 unique to the advertisement 450. When operator controller 302 receives advertisement 450, it compares Device UID 442 and message UID 452 to UID entries in table 446 and determines that message UID 452 is different than the message UID entry in table 446. In response to determining the new message UID 452, the controller generates and transmits a connection request 456 (substantially similar to connection request 412). In response, operator controller 302 receives connection response 456 (substantially similar to connection response 416) from control device 402, thereby forming a wireless connection between the operator 404 and control device 402. After the wireless connection is formed, operator controller purges the previous UID entries from table 446 and updates table 446 with device UID 442 and message UID 452 from advertisement 450 for future reference in determining whether to act upon or ignore future received advertisements, as has been discussed herein.

Those with skill in the art will recognize that FIG. 4B depicts just one illustrative example of how a connecting device determines whether to respond to or ignore an advertisement received from an advertising device. Additionally, while FIG. 4B depicts operator 404 sending a connection request in response to determining the received message UID of an advertisement does not match the message UID stored in table 446, those with skill in the art will recognize other examples are included as part of this disclosure. In some examples, operator 404 may be paired with multiple controlling devices, and there may be instances in which a message UID of an advertisement matches the message UID entry in table 446, but device UID of the received advertisement is different from the device UID stored in table 446. In this scenario, since the device UID is different than the device UID stored in table 446, the controller 302 is configured to attempt to connect with the control device responsive to the advertisement by sending a connection request. That is, controller 302 is configured to attempt to connect to an advertisement in response to determining at least one of the device UID and message UID of the received advertisement is different from the corresponding device UID and message UID stored in table 446.

Although operator 404 is depicted in FIG. 4B, those with skill in the art will recognize how the various connecting devices disclosed herein incorporate substantially the same operations, such as operator 406 previously discussed, for example.

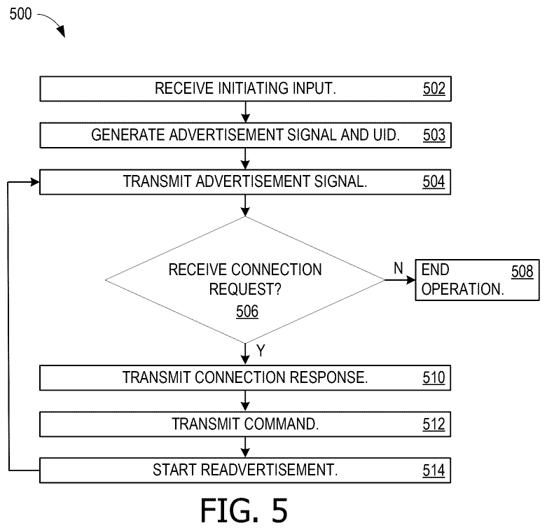

FIG. 5 is a flowchart illustrating a method 500 of performing a readvertising operation by a control device, such as control device 402 discussed in FIG. 4A, for forming wireless connections with a plurality of operators. Method 500 can be performed by controller 202. Method 500 can begin at block 502 by controller 202 receiving an initiating input at the control device 402 via a user interface of control device 402 (such as UI 231 previously discussed). For example, a button of control device 402 can be programmed for controlling all operators in a system such that when the button is pushed, all operators “open” or “close” their associated barriers. Further, in some examples the UI 231 is a pin pad, and the user can enter a pin code directing all operators in a system to “open” or “close” their associated barriers.

Method 500 can continue to block 503 by controller 202 generating an initial connection advertisement signal 410 for advertising to operators 404, 406 via communication circuit 208 and responsive to the type of input received in block 502. In generating the advertising signal 410, controller 202 generates the message UID 444, 452 to include in the PDU 440, 451 according to the various UID generation methods discussed herein. Controller 202 further includes fixed device UID 442 in PDU 440, 451. Method 500 can continue to block 504 where the controller 202 transmits the advertising signal to operators 404, 406 via communication circuit 208. Controller 202 is configured to advertise with the connection advertisement signal 410 for a predetermined advertisement time period, such as for 400 milliseconds, as has been previously described. Method 500 can continue to block 506 by controller 202 determining if a connection request from any of the operators 404, 406 has been received via communication circuit 208 during the advertisement time period. In response to determining that no connection request has been received from any of the operators 404, 406 during the advertisement time period, method 500 continues to block 508 by controller 202 ending the readvertisement program (as depicted with operation 434 in FIG. 4A, for example).

In response to receiving a connection request from one of the plurality of operators 404, 406, method 500 continues to block 510 by controller 202 transmitting a connection response to the corresponding operator via communication circuit 208. As previously discussed, when the control device 402 receives two or more connection requests 412, 414, controller 202 determines which connection request was received by control device 402 first and sends a connection response 416 responsive to the first connection request 412 received at the control device 402. That is, controller 202 sends connection response 416 to operator 404 because it received operator's 404 connection request 412 first. Thereby, a wireless connection is formed between operator 404 and control device 402. Method 500 can continue to block 512 by controller transmitting command signal 418, via communication circuit 208, instructing operator 404 to perform the command associated with the input received in block 502. Method 500 can continue to block 514 by controller 202 performing a readvertisement to connect with others of the plurality of operators.

Specifically, method 500 returns to block 504 where the advertisement is retransmitted (such as readvertisements 420, 430) by controller 202 via communication circuit 208. Those with skill in the art will understand how blocks 504-514 are repeated by controller 202 until all operators in a plurality of operators (such as operators 404, 406) are connected to and provided with the command associated with the input at block 502 (such as command signal 418, 428). As discussed, blocks 504-514 are repeated until controller 202 no longer receives connection request from any operators in block 506 during the advertisement period of time, and proceeds to end the readvertisement operation in block 508. Although blocks 502-514 are discussed in a certain order, blocks 502-514 can be performed in any of a number of orders without departing from the scope of this disclosure. Additionally, certain blocks or steps can be added or removed from method 500 without departing from the scope of this disclosure.

In some examples, with each new initiation of readvertising operation 500, controller 202 generates a new message UID to use in the associated connection advertisement signals 410, 420, 430. For example, if control device 402 is engaged by a user for a “close all doors” operation where control device 402 uses method 500 to close the barriers associated with operators 404, 406, a first message UID (for example, message UID 444) can be generated by controller 202 and used for connecting with the operators 404, 406. Then, at a later time, if control device 402 is engaged by a user for a “open all doors” operation where controlling device 402 uses method 500 to open the barriers associated with operators 404, 406, a second UID (for example, message UID 452) can be generated by controller 202 and used for connecting with the operators 404, 406. Those with skill in the art will recognize that, according to various examples, controller 202 generates a new message UID for each time method 500 is initiated at block 502.

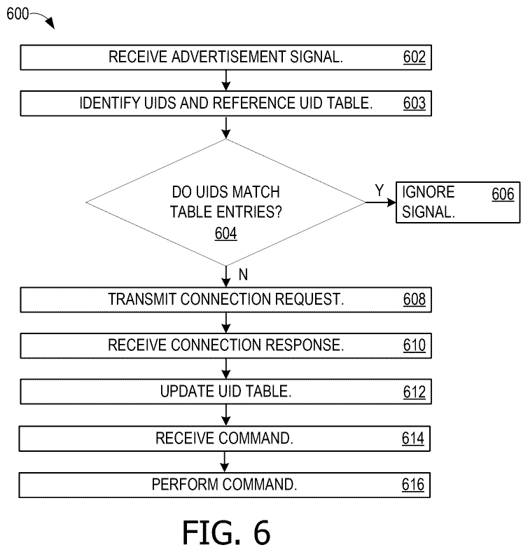

FIG. 6 is a flowchart illustrating a method 600 performed by an operator, such as operator 404, during a readvertisement operation, such as method 500 previously discussed. Specifically, method 600 can be performed by controller 302 of operator 404. Method 600 can begin at block 602 by controller 302 receiving connection advertisement signal 410 via communication circuit 308. Method 600 can continue to block 603 by controller 302 identifying the device UID 442 and message UID 444 included advertisement and refencing the identified UIDs against UID table 446 to determine whether operator 404 has already connected with a with control device 402 from an advertisement including the same message UID. Method 600 the continue to block 604 where controller 302 determines whether operator 404 has already connected with an advertisement including the same device and message UIDs by determining if the device and message UIDs of the advertisement match the current corresponding UID entries in table 446. In response to determining that the UIDs of the advertisement match the UID entries of table 446 and thus that operator's 404 most recent connection was formed responsive to an advertisement having the same UIDs as the advertisement received in block 602, the method proceeds to block 606 where the controller 302 ignores the advertisement signal received in block 602 (as described in operation 422 in FIG. 4A, for example).

In response to determining that at least one of the device UID and message UID of the advertisement do not match the corresponding entries of UID table 446 and thus determining that the operator's 404 most recent connection was not responsive to an advertisement with the UIDs included in the advertisement of block 602, the method continues to block 608. Said another way, if the device UID and/or the message UID in the advertisement of block 602 does not match the corresponding entry stored in UID table 446, method 600 continues to block 608. In block 608, controller 302 transmits a connection request 412 responsive to the connection advertisement received in block 602. Method 600 can continue to block 610, where controller 302 receives a connection response 416 responsive to connection request 412 and thereby forms a wireless connection with control device 402. After the wireless connection is formed, method 600 proceeds to block 612 where controller 302 updates the entries of UID table 446 to reflect the UIDs included in the advertisement received in block 602. In some examples, controller 202 deletes or otherwise clears previous entries from table 446 from its most recent connection and updates the table 446 with the device UID and message UID from the advertisement initiating the newly formed connection. In some examples, the table 446 entries are not overwritten until the operator 404 connects to the control device 402 and starts the message processing. This improves reliability, as it ensures the message is not processed before actually connecting to the device. In this way it is possible to recover from the failed connection attempt and connect to a subsequent advertisement because the device UID and its associated message UID are not stored in table 446 yet.

When the connection is established with control device 402, controller 302 can store the UIDs included in the advertisement signal 410 received in block 602 to memory 304 in table 446 for future reference in making determinations in block 604. Method 600 can continue to block 614 by receiving a command signal 418 from control device 402 and then performing the command on its associated moveable barrier in block 616. For example, controller 302 can actuate actuator 340 for moving the movable barrier according to command signal 418. Although blocks 602-614 are discussed in a certain order, blocks 602-614 can be performed in any of a number of orders without departing from the scope of this disclosure. Additionally, certain blocks or steps can be added or removed from method 600 without departing from the scope of this disclosure.

Those with skill in the art will understand that method 600 may be repeated multiple times by a given operator during the readvertising operation 500 of control device 402. For example, referring to FIG. 4A, operators 404, 406 each perform method 600 three times. Additionally, although operator 404 is used in describing method 600, those with skill in the art will understand how operator 406 uses method 600.

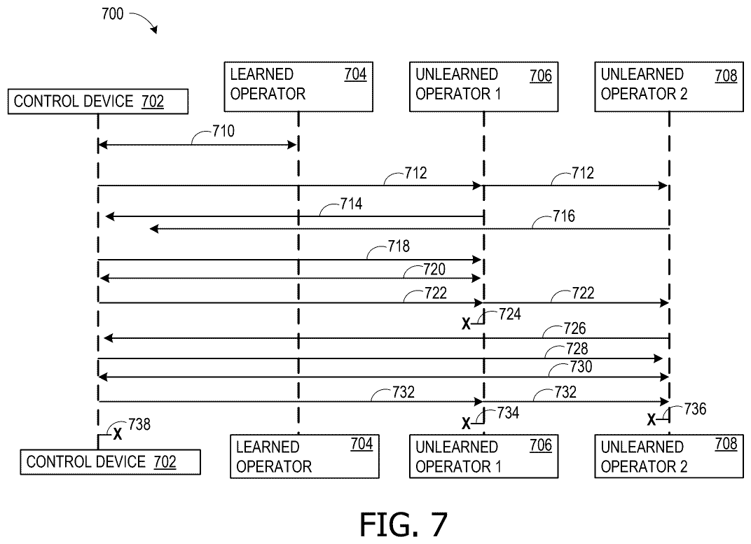

FIG. 7 illustrates a system 700 for performing a readvertising operation that includes advertising to unlearned operators. As those with skill in the art will understand, system 700 is substantially similar to system 400 previously discussed, but system 700 further includes operators that are unlearned to the control device. System 700 comprises control device 702 which can comprise control device 200 and operators 704-708 which can each comprise operator 300. Control device 702 first performs readvertising operations for connecting with learned operators such as operator 704, according to the readvertising operations previously discussed in FIG. 4A. The readvertising and connecting with learned operator 704 as discussed in FIG. 4A is depicted with line 710. In system 700, one learned operator 704 is shown, but system 700 can include a plurality of learned operators and control device 702 can perform the readvertising operations previously discussed in FIGS. 4A-6 for connecting with each of the learned operators.

After connecting with the learned operators, control device 702 transmits an advertising signal 712 for initiating a learning operation for any operators in system 700 placed in a learning mode for learning control device 702, such as unlearned operators 706, 708. Each operator 706, 708 analyzes the UIDs of advertising signal to determine if the operator has engaged in a learning operation with the control device 702, similar to the UID analysis previously discussed in FIGS. 4B and 6, for example. In response to determining that the operator has not learned or been paired with the control device 702 with the UIDs in signal 712, unlearned operators 706, 708 transmit connection request 714, 716 requesting connection for learning control device 702. Similar to operations in system 400 and method 500, control device 702 responds to the first connection request received, which as shown is connection request 714. Accordingly, control device 702 transmits a learning mode connection response 718 to operator 706 since operator's 706 request 714 was first received by control device 702. Thereby, a wireless connection for performing a learning mode operation is formed and control device 702 and operator 706 transmit appropriate information for performing a learning operation, as shown by line 720, so that the operator 706 can learn or be paired with control device 702 and vice versa. In some examples, after learning operator 706, control device 702 transmits the operation command that was sent to the learned operator 704 during connection 710.

Similar to the operations previously discussed in FIGS. 4A-5, after learning operator 706, control device 702 retransmits the advertising signal for learning unlearned operators as signal 722 having the same UIDs as signal 712, which is received by operators 706, 708. Operator 706 analyzes signal 722 and determines it has already learned control device 702 responsive to advertisement 712 based on recognizing the UIDs of 722 and thus ignores 724 readvertised signal 722. Unlearned operator 708 does not recognize learning a device with the UIDs of signal 722 and thus transmits a learning mode request 726 responsive to readvertised signal 722. Control device 702 transmits a response 728 to operator 708 thereby forming a connection for transferring learning information between control device 702 and operator 708, as shown with line 730. In some examples, after learning operator 708, control device 702 transmits the operation command that was sent to the learned operator 704 during connection 710.

After learning operator 708, control device 702 retransmits the advertising signal for learning unlearned operators as signal 732 having the same UIDs as signals 712, 722, which is received by operator 706, 708. Both operators 706, 708 recognize that they have already learned a device with the UIDs of signal 732 and thus ignore 734, 736 the readvertised signal 732. In response to not receiving any request responsive to signal 732 in predetermined request receiving period of time, control device 702 terminates 738 the readvertising operation.

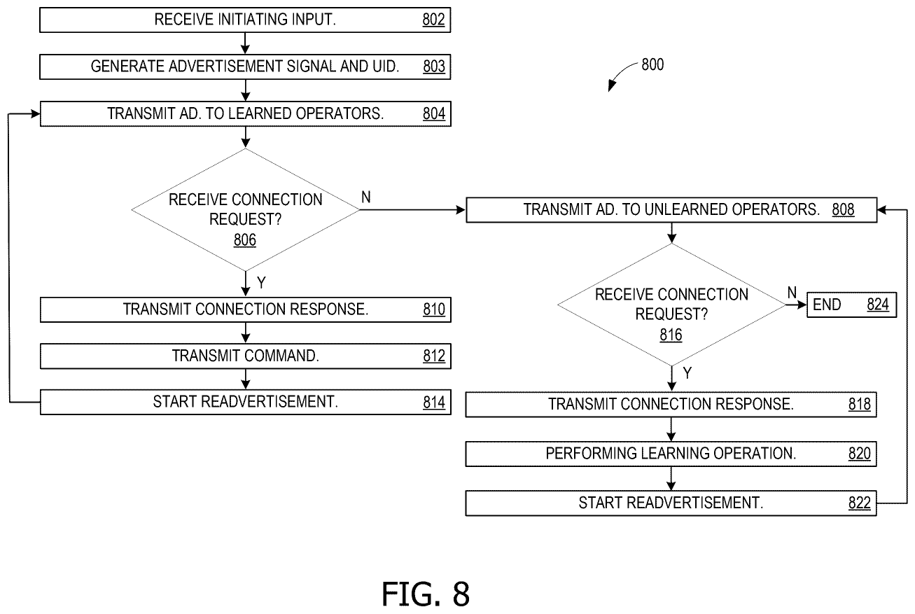

FIG. 8 illustrates a method 800 for performing a readvertising operation by a control device, such as control device 702, according to another example of this disclosure. The method 800 can be performed by controller 302 of control device 702. Specifically, method 800 can be used for connecting with learned operators and also for learning or pairing with unlearned operators. Method 800 is substantially similar to method 500 previously described. Specifically, blocks 802, 803, 804, 806, 810, 812, and 814 for connection to learned operators such as operator 404, 406, 704 are substantially the same as corresponding blocks 502, 503, 504, 506, 510, 512, and 514 of method 500 previously discussed.

However, instead of ending the readvertising program in response to receiving no connection request in block 806, method 800 continues to block 808 by controller 202 transmitting an advertisement signal, such as signal 712 via communication circuit 208, for learning unlearned operators placed in a learning mode, such as operators 706, 708. Method 800 can proceed to block 816 where controller 202 determines if connection requests are received via communication circuit 208 during a predetermined request period of time, substantially similar to the period of time discussed in blocks 806 and 506, for example. If connection requests are received, such as requests 714, 716, method 800 continues to block 818 where controller 202 transmits a response, such as response 718, 728, for connecting with the operator. As has been previously discussed (such as in block 510), in response to receiving two or more requests in block 816, controller 202 will transmit a connection response responsive to the first request received by control device 702. For example, controller 202 determines request 714 is received before request 716 and thus transmits a connection response 718 to operator 706 since operator 706 is the source of the first request 714 received by control device 702. Method 800 continues to block 820, where control device 702 and operator 706, 708 perform a learning operation 720, 730 where appropriate data is relayed between the devices in order to learn or pair with each other. Additionally, in some examples, the command of block 812 is transmitted from control device 702 to operator 706, 708 for the operator to perform after learning control device 702. Method 800 can continue to block 822 where the readvertisement process is initiated and a readvertisement signal (such as readvertised signals 722, 732) is transmitted by controller 2020 via communication circuit 208. The above referenced steps are repeated until controller 202 no longer receives a connection request via communication circuit 208 within the predetermined request receiving period of time in block 816, and method 800 proceed to block 824 where controller 202 ends the readvertising operation.

Although blocks 802-824 are discussed in a certain order, blocks 802-824 can be performed in any of a number of orders without departing from the scope of this disclosure. Additionally, certain blocks or steps can be added or removed from method 800 without departing from the scope of this disclosure. Additionally, those with skill in the art will recognize method 800 illustrates actions taken by control device 702 in system 700. Operations taken by operators 706, 708 will be understood by those with skill in the art based on the descriptions accompanying FIGS. 7 and 8. Additionally, operations taken by operator 706, 708 are substantially the same as those described in method 600. However, instead of processing a signal to determine if the operator has connected with the control device for performing a command, operators 706, 708 determine, based on the UIDs, whether the operator has engaged in a learning or pairing operation with the control device 702 for ultimately performing a pairing or learning operation with the control device 702 in response to determining that the operator has not already learned the control device 702. Those with skill in the art will recognize how the action performed by operators 706, 708 are substantially the same as method 600 for the purpose of ultimately performing a pair or learning operation with control device 702.

Those with skill in the art will understand that there are various practical scenarios in which the readvertising systems and operations described in the systems and methods herein can be utilized. For example, in a commercial setting, a commercial warehouse or similar building may have numerous moveable barriers in the form of overhead doors for accessing the warehouse. At the end of a workday, many or all of the overhead doors may be open and thus need to be closed for closing down the warehouse. The readvertising systems and operations herein can be used at the end of the day in a “close all doors” scenario in order to close all doors for closing down the warehouse. The operator could activate a button of a single control device to connect with and then send a “close door” operation command to each of the operators in the warehouse. Additionally, as discussed, the control device could include a pin code pad. Each door could have its own pin code for operating a given door, and there could also be a pin code used to “open all doors” and a pin code used to “close all doors” using the readvertising operations and systems disclosed herein.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.” Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. An advertising device configured to perform a readvertising operation for wirelessly connecting with a plurality of connecting devices, comprising:
a wireless communication module; and
a processor coupled with the wireless communication module and a memory storing instructions operable by the processor to:
transmit an advertising signal for establishing connection with the plurality of connecting devices, the advertising signal including a unique identifier (UID),
receive a plurality of connection requests, each of the plurality of connection requests transmitted from one of the plurality of connecting devices responsive to the advertising signal,
determine which of the plurality of connection request is a first connection request that is received by the advertising device first of out of the plurality of connection requests,
transmit a first connection response to a first connecting device of the plurality of connecting devices from which the first connection request was transmitted, thereby establishing a first wireless connection between the advertising device and the first connecting device, and
in response to establishing the first wireless connection, retransmit the advertising signal including the UID for establishing connection with the plurality of connecting devices.

2. The advertising device of claim 1, wherein the memory further store instructions operable by the processor to:
receive a plurality of second connection requests, each of the plurality of second connection requests transmitted from one of the plurality of connecting devices responsive to the retransmitted advertising signal;
determine which of the plurality of connection requests is a first second connection request that was received by the advertising device first of out of the plurality of second connection requests; and
transmit a second connection response to a second connecting device from which the first second connection request was transmitted, thereby establishing a second wireless connection between the advertising device and the second connecting device.

3. The advertising device of claim 2, wherein:
the advertising device is a remote controller;
the first connecting device comprises a first operator coupled with and configured to operate a first movable barrier based on commands of the remote controller; and
the second connecting device comprises a second operator coupled with and configured to operate a second movable barrier based on commands of the remote controller.

4. The advertising device of claim 3, wherein the memory further stores instructions executable by the processor to:
in response to establishing the first wireless connection, transmitting a first command signal commanding the first operator to perform a first action with the first movable barrier; and
in response to establishing the second wireless connection, transmitting a second command signal commanding the second operator to perform a second action with the second movable barrier.

5. The advertising device of claim 4, wherein the second command signal is the same as the first command signal such that the second action performed with the second movable barrier is the same as the first action performed with the first movable barrier.

6. The advertising device of claim 1, wherein the memory further stores instructions operable by the processor to, in response to receiving no connection requests from any of the plurality of connecting devices within a predetermined time period, ending the readvertising operation.

7. The advertising device of claim 1, wherein:
some of the plurality of connecting devices are learned to the advertising device and some of the plurality of connecting devices are unlearned to the advertising device,
the advertising device is first configured to send the advertisement signal for connecting to the connecting devices learned to the advertising device and, in response to determining all connecting devices learned to the advertising device have been connected, transmitting a learning advertisement signal for learning the connecting devices unlearned to the advertising device.

8. A system of a plurality of connecting devices configured to wirelessly connect with an advertising device via a readvertising operation, comprising:
a first connecting device and a second connecting device of the plurality of connecting devices each configured to:
receive an advertising signal transmitted by the advertising device, the advertising signal including a unique identifier (UID), and
transmit a connection request to the advertising device in response to receiving the advertising signal, wherein the connection request belonging to the first connecting device is first received by the advertising device,
wherein:
the first connecting device is configured to receive a first connection response from the advertising device based on the connection request from the first connecting device being received first by the advertising device, thereby establishing a first wireless connection between the advertising device and the first connecting device,
each of the first and the second connecting devices are configured to receive a retransmission of advertising signal including the UID retransmitted by the advertising device,
the first connecting device is configured to ignore the retransmitted advertising signal in response to recognizing the UID based the first wireless connection, and
the second connecting device is configured to send a second connection request in response to receiving the retransmission of the advertising signal.

9. The system of claim 8, wherein the second connecting device is further configured to receive a second connection response from the advertising device, thereby establishing a second wireless connection between the advertising device and the second connecting device.

10. The system of claim 9, wherein:
the first connecting device comprises a first operator coupled with and configured to operate of a first movable barrier;
the second connecting device comprises a second operator coupled with and configured to operate of a second movable barrier; and
the advertising device is a remote controller for the first and the second operators.

11. The system of claim 10, wherein:
in response to establishing the first wireless connection, the first operator is configured to receive a first command signal from the remote controller commanding the first operator to perform a first action with the first movable barrier; and
in response to establishing the second wireless connection, the second operator is configured to receive a second command signal from the remote controller commanding the second operator to perform a second action with the second movable barrier.

12. The system of claim 11, wherein the second command signal is the same as the first command signal such that the second action performed with the second movable barrier is the same as the first action performed with the first movable barrier.

13. A method for wirelessly connecting an advertising device with a plurality of connecting devices by a readvertising operation, comprising:
transmitting, by the advertising device, an advertising signal for establishing connection with the plurality of connecting devices, the advertising signal including a unique identifier (UID);
receiving, by the plurality of connecting devices, the advertising signal;
determining, by each of the plurality of connecting devices, whether the connecting device has connected with the advertising device based on recognition of the UID;
for each of the plurality of connecting devices determining that the connecting device has connected with the advertising device based on recognizing the UID, ignoring the advertising signal;
for each of the plurality of connecting devices determining that the connecting device has not connected with the advertising device based on not recognizing the UID, transmitting a connection request;
receiving, by the advertising device, a plurality of the connection requests;
determining, by the advertising device, which of the plurality of connection requests is a first connection request that was received by the advertising device first of out of the plurality of connection requests;
transmitting, by the advertising device, a first connection response to a first connecting device of the plurality of connecting devices from which the first connection request was transmitted, thereby establishing a first wireless connection between the advertising device and the first connecting device; and
in response to establishing the first wireless connection, retransmitting, by the advertising device, the advertising signal including the UID for establishing connection with the plurality of connecting devices.

14. The method of claim 13, wherein:
each of the plurality of connecting devices comprises an operator operably coupled with a movable barrier; and
the advertising device is a remote controller for controlling operations of the operators.

15. The method of claim 13, further comprising:
in response to establishing the first wireless connection, transmitting, by the advertising device, a first command signal commanding the first connecting device to perform an action.

16. The method of claim 13, wherein, in response to receiving the retransmitted advertising signal, the first connecting device is configured to ignore the retransmitted advertising signal based on recognizing the UID from the first wireless connection.

17. The method of claim 13, further comprising, in response to receiving no connection requests from any of the plurality of connecting devices within a predetermined time period, ending the readvertising operation.

18. The method of claim 13, wherein
some of the plurality of connecting devices are learned to the advertising device and some of the plurality of connecting devices are unlearned to the advertising device,
the advertising device is first configured to send the advertising signal for connecting to the connecting devices learned to the advertising device and, in response to determining all the connecting devices learned to the advertising device have been connected, transmitting a learning advertisement signal for learning the connecting devices unlearned to the advertising device.

19. The method of claim 13, wherein the readvertising operation is performed in order for the advertising device to connect with the plurality of connecting devices in order for the advertising device to send a common operation demand to each of the plurality of connecting devices.

20. The method of claim 19, wherein:
the advertising device comprises a control device;
each of the plurality of connecting devices comprises an operator operably coupled to a movable barrier; and
the common operation command is a command for each of the operators to perform on its movable barrier.
